(19) United States
(12) Patent Application Publication
(10) Pub. No.: US 2010/0008826 A1
(43) Pub. Date: Jan. 14, 2010

(54) Biosensors featuring confinement of deposited material and intra-well self-referencing

(75) Inventor: Stephen C. Schulz, Lee, NH (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: SRU Biosystems, Inc.

(21) Appl. No.: 12/218,096

(22) Filed: Jul. 10, 2008

(51) Int. Cl. G01N 21/00

(52) U.S. Cl. 422/82.05

(57) ABSTRACT

A test device includes one or more sample wells and a biosensor placed in the well. The biosensor includes structural features promoting confinement of a deposited material, e.g., surface chemistry material, to stay within a specified predetermined area in the well. The biosensor is also constructed with two or more distinct spatial regions exhibiting different resonance values (“peak wavelength values” or PWV). One of the distinct spatial regions encompasses the specified predetermined area where the material is deposited and exhibits resonance at PWV1. A distinct spatial region surrounding the specified predetermined area exhibits resonance at PWV2. A buffer zone may be provided between the two areas. The device enables detection of lower analyte concentrations and improves intra-well self-referencing capability for the biosensor.

### BACKGROUND

A. Field of the Invention

This invention relates generally to biosensor devices designed for optical detection of the adsorption of a biological or chemical analyte, such as DNA, protein, viruses or cells, or chemicals, onto a surface of the device or within a volume of the device.

In this document, the term “analyte” is used to refer to a species in solution that binds to an immobilized target species on the surface of the biosensor. A material in the form of a reactive coating (referred to herein as “surface chemistry”), e.g., polyvinyl alcohol (PVA), is deposited on some area of the biosensor, and binds the target species in relatively high density to the biosensor. Subsequently, the biosensor detects binding of the analyte to the target species. Biosensor transduction of analyte-target species binding comprises the assay signal. In label-free photonic crystal biosensors, this assay signal is determined by a shift in the peak wavelength value of reflected light from the surface of the biosensor when the biosensor is in a resonant condition, with the amount of the shift being related the amount of analyte-target species binding.

B. Description of Related Art

Grating-based biosensors represent a new class of optical devices that have been enabled by recent advances in semiconductor fabrication tools with the ability to accurately deposit and etch materials with precision less than 100 nm.

Several properties of photonic crystals make them ideal candidates for application as grating-type optical biosensors. First, the reflectance/transmittance behavior of a photonic crystal can be readily manipulated by the adsorption of biological material such as proteins, DNA, cells, virus particles, and bacteria. Each of these types of material has demonstrated the ability to alter the optical path length of light passing through them by virtue of their finite dielectric permittivity. Second, the reflected/transmitted spectra of photonic crystals can be extremely narrow, enabling high-resolution determination of shifts in their optical properties due to biochemical binding while using simple illumination and detection apparatus. Third, photonic crystal structures can be designed to highly localize electromagnetic field propagation, so that a single photonic crystal surface can be used to support, in parallel, the measurement of a large number of biochemical binding events without optical interference between neighboring regions within <3-5 microns. Finally, a wide range of materials and fabrication methods can be employed to build practical photonic crystal devices with high surface/volume ratios, and the capability for concentrating the electromagnetic field intensity in regions in contact with a biochemical test sample. The materials and fabrication methods can be selected to optimize high-volume manufacturing using plastic-based materials or high-sensitivity performance using semiconductor materials.

Representative examples of grating-type biosensors in the prior art are disclosed in Cunningham, B. T., P. Li, B. Lin, and J. Pepper, Colorimetric resonant reflection as a direct biochemical assay technique. Sensors and Actuators B, 2002. 81: p. 316-328; Cunningham, B. T., J. Qiu, P. Li, J. Pepper, and B. Hugh, A plastic colorimetric resonant optical biosensor for multiparallel detection of label-free biochemical interactions, Sensors and Actuators B, 2002. 85: p. 219-226; Haes, A. J. and R. P. V. Duyne, A Nanoscale Optical Biosensor: Sensitivity and Selectivity of an Approach Based on the Localized Surface Plasmon Resonance Spectroscopy of Triangular Silver Nanoparticles. Journal of the American Chemical Society, 2002. 124: p. 10596-10604.

The combined advantages of photonic crystal biosensors may not be exceeded by any other label-free biosensor technique. The development of highly sensitive, miniature, low cost, highly parallel biosensors and simple, miniature, and rugged readout instrumentation will enable biosensors to be applied in the fields of pharmaceutical discovery, diagnostic testing, environmental testing, and food safety in applications that have not been economically feasible in the past.

In order to adapt a photonic bandgap device to perform as a biosensor, some portion of the structure must be in contact with a test sample. Biomolecules, cells, proteins, or other substances are introduced to the portion of the photonic crystal and adsorbed where the locally confined electromagnetic field intensity at resonance is greatest. As a result, the resonant coupling of light into the crystal is modified, and the peak wavelength of the reflected/transmitted output (i.e., peak wavelength value or “PWV” herein) is tuned, i.e., shifted. The amount of shift in the PWV is related to the amount of substance present on the sensor. The sensors are used in conjunction with an illumination and detection instrument that directs polarized light into the sensor and captures the reflected or transmitted light. The reflected or transmitted light is fed to a spectrometer that measures the shift in the peak wavelength.

The ability of photonic crystals to provide high quality factor (Q) resonant light coupling, high electromagnetic energy density, and tight optical confinement can also be exploited to produce highly sensitive biochemical sensors. Here, Q is a measure of the sharpness of the peak wavelength at the resonant frequency. Photonic crystal biosensors are designed to allow a liquid test sample to penetrate the periodic lattice, and to tune the resonant optical coupling condition through modification of the surface dielectric constant of the crystal through the attachment of biomolecules or cells. Due to the high Q of the resonance, and the strong interaction of coupled electromagnetic fields with surface-bound materials, several of the highest sensitivity biosensor devices reported are derived from photonic crystals. See the Cunningham et al. papers cited previously. Such devices have demonstrated the capability for detecting molecules with molecular weights less than 200 Daltons (Da) with high signal-to-noise margins, and for detecting individual cells. Because resonantly-coupled light within a photonic crystal can be effectively spatially confined, a photonic crystal surface is capable of supporting large numbers of simultaneous biochemical assays in an array format, where neighboring regions within ˜10 μm of each other can be measured independently. See Li, P., B. Lin, J. Gerstenmaier, and B. T. Cunningham, A new method for label-free imaging of biomolecular interactions. Sensors and Actuators B, 2003.

There are many practical benefits for biosensors based on photonic crystal structures. Direct detection of biochemical and cellular binding without the use of a fluorophore, radioligand or secondary reporter removes experimental uncertainty induced by the effect of the label on molecular conformation, blocking of active binding epitopes, steric hindrance, inaccessibility of the labeling site, or the inability to find an appropriate label that functions equivalently for all molecules in an experiment. Label-free detection methods greatly simplify the time and effort required for assay development, while removing experimental artifacts from quenching, shelf life, and background fluorescence. Compared to other label-free optical biosensors, photonic crystals are easily queried by simply illuminating at normal incidence with a broadband light source (such as a light bulb or LED) and measuring shifts in the reflected color. The simple excitation/readout scheme enables low cost, miniature, robust systems that are suitable for use in laboratory instruments as well as portable handheld systems for point-of-care medical diagnostics and environmental monitoring. Because the photonic crystal itself consumes no power, the devices are easily embedded within a variety of liquid or gas sampling systems, or deployed in the context of an optical network where a single illumination/detection base station can track the status of thousands of sensors within a building. While photonic crystal biosensors can be fabricated using a wide variety of materials and methods, high sensitivity structures have been demonstrated using plastic-based processes that can be performed on continuous sheets of film. Plastic-based designs and manufacturing methods will enable photonic crystal biosensors to be used in applications where low cost/assay is required, that have not been previously economically feasible for other optical biosensors.

The assignee of the present invention has developed a photonic crystal biosensor and associated detection instrument. The sensor and detection instrument are described in the patent literature; see U.S. patent application publications U.S. 2003/0027327; 2002/0127565, 2003/0059855 and 2003/0032039. Methods for detection of a shift in the resonant peak wavelength are taught in U.S. Patent application publication 2003/0077660. The biosensor described in these references include 1- and 2-dimensional periodic structured surfaces applied to a continuous sheet of plastic film or substrate. The crystal resonant wavelength is determined by measuring the peak reflectivity at normal incidence with a spectrometer to obtain a wavelength resolution of 0.5 picometer. The resulting mass detection sensitivity of <1 pg/mm² (obtained without 3-dimensional hydrogel surface chemistry) has not been demonstrated by any other commercially available biosensor.

A fundamental advantage of the biosensor devices described in the above-referenced patent applications is the ability to mass-manufacture with plastic materials in continuous processes at a 1-2 feet/minute rate. Methods of mass production of the sensors are disclosed in U.S. patent application publication 2003/0017581. Further details on the construction of readers for reading photonic crystal biosensors are set forth in the published U.S. Patent Application 2003/0059855. After manufacture of the sensors per se, the biosensors are attached to the bottom of a bottomless microwell plate or similar test format to form a test device ready for use. Such structures are described in the above-referenced patent documents.

Other prior art of interest include U.S. Pat. No. 7,264,973; U.S. Pat. No. 7,309,614; and U.S. Patent application publication 2006/0141527.

In general, it is desirable to have a high signal in the presence of low analyte concentration. The size of the biosensor area occupied by the target determines the analyte lower detection limit (LDL) proportionally. Smaller target spots on the surface of the biosensor require less analyte in the well to produce a given biosensor signal. The biosensor surface structure and or factors affecting biosensor surface energy can render the deposition of small surface chemistry spots difficult. For example, one dimensional biosensor structures (gratings) cause liquid place on the surface to flow in the direction of the grating lines. The material spreads towards the well wall. Contact with the wall causes the surface chemistry material to climb the wall and thus coat an excessively large area.

U.S. Pat. No. 7,309,614 introduced the concept of intra-well referencing to normalize the biosensor signal against temperature and composition induced bulk refractive index changes. The concepts described herein improve the feasibility and practicality of this technique. The invention makes intrawell referencing particularly viable with the high throughput BIND plate reader of the applicant's assignee, rather than relying on the high resolution imager such as the BIND Scanner of the applicant's assignee.

All of the previously cited art is fully incorporated by reference herein.

### SUMMARY

This document describes novel sub-wavelength resonant biosensors such as photonic crystal biosensors that have several advantages:

(1) Deposition of small target (protein) spots within a sample well enabling detection of lower analyte concentrations. Biosensors structures are described herein which help confine the deposition of surface chemistry to stay within a specified predetermined area. In particular, specific patterning of the grating structures of the biosensor's active areas helps prevent spreading of surface chemistry materials outside the intended target area.

(2) Improving intra-well self-referencing capability. This is an important feature for high throughput reading instruments which read test devices, such as microwell plates, which incorporate the biosensors as described herein.

In one aspect of this invention, a test device is disclosed which comprises structure forming a sample well, and a biosensor placed in the sample well. The structure forming the sample well may take the form of a multi-well plate or other test device format featuring a sample well. The biosensor incorporates two features, namely 1) a structural feature promoting confinement of a material (e.g., surface chemistry material) deposited in the well to stay within a specified predetermined area on the biosensor surface; and 2) the biosensor is further constructed with two or more distinct spatial regions exhibiting different resonance values (PWV1, PVW2, . . . ) of sufficient spectral separation in response to illumination of the biosensor with light whereby the spectral separation can be resolved by a detection instrument reading the test device. The required spectral separation of the different PWV values will vary depending on the sensitivity of the detection instrument, the number of different regions, and other factors, however a spectral separation of between 5 and 15 nm is specifically contemplated.

One of the distinct spatial regions encompasses the specified predetermined area where the material is deposited, and another of the distinct spatial regions encompasses a region surrounding the specified predetermined area. This feature of the two distinct spatial regions promotes a self referencing capability, as will be described in greater detail below. Basically, the combination of the confinement and distinct spatial regions with different resonance values serve to decrease the analyte lower detection limit, and increase the signal to noise ratio at a given analyte concentration. Small target spots reduce the absolute quantity of bound analyte required to achieve a certain signal level. Introduction of intra-well referencing capability decreases biosensor noise.

In one specific embodiment, the biosensor takes the form of a photonic crystal biosensor. However, the features of this invention can be used with other grating-based biosensors, such as so-called evanescent resonance (ER) biosensors which detect labeled analytes.

Various spatial arrangements for the first and second spatial regions are disclosed. In one example, the first spatial region is a region occupying the center of the well and the second spatial region is a region occupying a region peripheral to center of the well. Several types of checkerboard configurations are also disclosed. Additionally, the spatial regions can be arranged in clusters, separated by buffer zones. In some embodiments, each of the clusters includes at least 3 distinct spatial regions, each exhibiting different resonance values. Embodiments are described with clusters composed of 9 different spatial regions, each with its own distinct PWV.

The structural feature on the biosensor surface promoting confinement of the deposited material in the well to stay within a specified predetermined area can take several forms. In one form, the structural feature takes the form of periodic gratings which are oriented in alignment with a boundary of the predetermined area, and the orientation of the gratings inhibits migration, e.g., by capillary action, of the deposited material beyond the specified predetermined area. For example, the predetermined area can take the form a circular region located in the center of the well and the structural region is in the form of an annular buffer region which has gratings oriented in concentric circles surrounding the central circular region. In another embodiment, the structural feature promoting confinement of the deposited material takes the form of raised areas on the surface of the biosensor.

In another aspect, a testing device is disclosed comprising a multi-well test device having a multitude of sample wells, each of the wells having a bottom; and a photonic crystal biosensor placed at the bottom of each of wells. For each well, the photonic crystal biosensor is constructed with a first periodic grating structure designed to exhibit a first peak wavelength value (PWV1) in a resonance condition, the first periodic grating structure located in a first spatial region of the well, and a second periodic grating structure designed to exhibit a second peak wavelength value (PWV2) in a resonance condition, the second periodic grating structure located in a second spatial region of the well. The first and second spatial regions comprise distinct spatial regions of the well.

In example embodiments, the first and second spatial regions are separated from each other by a buffer region. In other embodiments, the spatial regions are touching each other (having at least one common border with another region) and are further arranged in clusters. The clusters are isolated from each other by buffer regions. There may be two or more clusters per well.

The buffer regions are constructed with a periodic surface grating in a manner designed to inhibit a liquid phase material deposited in the first region to migrate into the second spatial region. For example, the periodic surface grating of the buffer region is constructed with gratings which are in alignment with the outline form of the first spatial region. For example, the first spatial region producing PWV1 has a round outline form and the buffer region is an annular region surrounding the round outline form, in which the gratings of the buffer region are arranged as concentric circles. As another example, the first spatial region has a rectangular outline form having four sides, and the gratings of the buffer region are oriented in alignment with the four sides of the rectangular outline form. Additionally, the buffer region may include a region exhibiting a peak wavelength value different from the peak wavelength value of the spatial regions producing PWV1 and PWV2.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a perspective view of a portion of a multi-well device having a multitude of sample wells. A grating-based biosensor is placed at the bottom of the sample wells.

FIG. 2 is a cross-sectional view of the device of FIG. 1, taken along the lines 2-2 of FIG. 1.

FIG. 3 is a plan view of one of the wells of FIG. 3, showing the layout of the biosensor at the bottom of the well and a surface chemistry deposit placed in the well. The biosensor has one primary detection region occupying a spatial region in the center, which is constructed with a grating structure designed to exhibit resonance at one wavelength (“PWV 1”). The biosensor has a secondary, peripheral region occupying a distinct spatial region surrounding the primary region which is constructed with a grating structure designed to exhibit resonance at a second wavelength (PWV 2”). The spatial two regions are separated by an annular buffer region. The buffer region has features to inhibit migration of a deposited surface chemistry solution from the central region to the peripheral region, such as for example gratings arranged as concentric circles or gratings having raised portions of a height greater than the height of the grating in the central region.

FIG. 4 is a plan view of an alternative embodiment of the biosensor arrangement of FIG. 3, in which the each well has one primary detection region which is constructed with a grating structure designed to exhibit resonance at one wavelength, and four secondary regions surrounding the primary region, each of which is constructed with a grating structure designed to exhibit resonance at a second wavelength. The primary region and the four secondary regions are separated by buffer regions.

FIG. 5 is a plan view of a microwell test device having a plurality of wells occupied by biosensors, in which the biosensors for each well are constructed as clusters of nine spatial regions, each spatial region constructed with a different periodic surface grating structure such that the clusters exhibit nine different resonance wavelengths.

FIG. 6 is a schematic illustration of the microwell test device of FIG. 5, showing successive positions in which a reader of the microwell test device obtains PWV measurements. The instrument collects peak wavelength value measurements from nine regions of the biosensor at each position. Provided sufficient spectral separation for each PWV measurements exists for each of the nine regions (preferably at least 5 nm), the instrument can obtain nine different PWV measurements at the same time from one or more clusters.

FIG. 7 is a plot of resonance wavelength as a function of photonic crystal period for a one dimensional periodic surface grating for incident radiation in a TM mode, a grating depth of 275 nm, and an 85 nm TiO₂ high index of refraction coating on the grating.

FIG. 8 is a detailed view of a portion of a grating-based biosensor showing a portion of periodic surface grating structure and the elements of a reader for reading the biosensor. The circles represent a target species which are applied to the surface of the biosensor and the “+” symbols represent an analyte which binds to the target species. In some embodiments, the target species is bound to the surface of the grating structure. In one possible embodiment, the target species are unbound cells and the analyte is a test compound which engenders significant motion in the cells.

FIG. 9 is an illustration of a plate reader and associated computer workstation for reading the microwell test devices and obtaining PWV measurements from the biosensors in the test devices.

FIG. 10 is an illustration of another alternative configuration of the biosensors for the multi-well test devices. The biosensor consists of concentric circular regions and a central region. Each region has a different grating structure such that each region exhibits a different PWV resonance wavelength. Cells are seeded onto the biosensor in approximately the middle of the unit cell. The regions at the periphery of the unit cell are coated with test compounds which are attractive (or repulsive) to the cells. By measuring the shifts in PWV measurements in each of the regions over time, the device can be used to measure cell migration towards or away from the test coatings.

### DETAILED DESCRIPTION

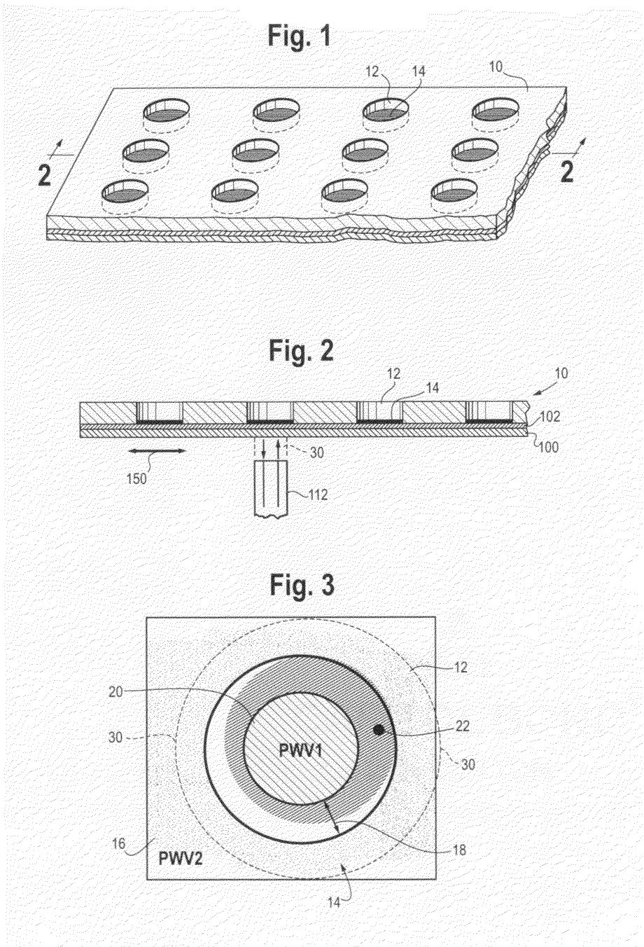

FIG. 1 is a perspective view of a portion of a multi-well test device 10 having a structure forming a multitude of sample well 12. A biosensor 14 is placed at the bottom of the sample wells. In the illustrated embodiment the biosensor is a photonic crystal biosensor. However, other grating-based optical biosensors are also possible for use as the biosensor 14. FIG. 2 is a cross-sectional view of the test device 10 of FIG. 1, taken along the lines 2-2 of FIG. 1. FIG. 8 is a more detailed cross-sectional view. The test device 10 is in the form of a bottomless multi-well microplate. The biosensor 14 consists of a grating layer 102 which is formed on a transparent substrate material 100 such as polyethylene terepthalate (PET) sheet. A layer of high index of refraction material 104 (FIG. 8) is deposited on the surface of the grating layer 102. The construction of layers 100, 102 and 104 are bonded to the bottom of the test device such that the biosensor 14 forms the bottom surface of the wells 14. The device is interrogated with light from a fiber in a dual fiber bundle 112 and the illumination of the device at certain wavelengths produces a resonance in the biosensor. Reflected light is captured by another fiber in the bundle 112 and supplied to a spectrometer. Binding of an analyte to the surface of the biosensor 14 produces a shift in the peak wavelength value of the reflected light and this shift is detected by the spectrometer.

FIG. 3 is a plan view of one of the wells 12 of FIGS. 1 and 2, showing the layout of the biosensor 14 at the bottom of the well and a surface chemistry deposit 22 placed in the well. The surface chemistry deposit 22 is shown in dark hatching in FIG. 3. The biosensor has one primary detection region 20 located in the center of the well 12 which is constructed with a grating structure designed to exhibit resonance at one wavelength (“PWV 1”). The biosensor 14 has a secondary, peripheral region 16 surrounding the primary region which is constructed with a grating structure designed to exhibit resonance at a second wavelength (PWV 2”). The two regions are spatially separated from each other by an annular buffer region 18. The buffer region 18 has features to inhibit migration of the surface chemistry solution 22 from the central region 20 to the peripheral region 16, such as for example surface grating structures arranged as concentric circles concentric with the peripheral outline of the central region 20. Alternatively, the gratings in the buffer zone 18 have raised portions of a height greater than the height of the gratings in the central region 20.

The plate reader for the instrument reading the test device 10 illuminates and measures the biosensor resonance position from some area of the micro-plate well 12 prescribed by the diameter of an aperture in the reader optical path. This “read area” is a circular area shown in dashed lines at 30 in FIGS. 2 and 3 and typically has a diameter range of 1 to 3 mm. This disclosure contemplates the specific and typical case where the aperture size 30 results in a read area which is of greater areal extent than a surface chemistry-target spot 22 within the well. Hence, measured light comes from both the biologically active spot 22 and the significantly less active sensor area outside the spot, i.e., the buffer zone and the region “PWV2”. Such a condition will produce resonance measurements with two distinct wavelengths. For discussion purposes, PWV1 (peak wavelength value 1) comes from region 20, i.e., the region of the biosensor where the target spot and surface chemistry coating covers the biosensor. PWV2 comes from region 16, which is spatially separate and outside region 20, i.e., the region of the biosensor where the biosensor does not have a surface chemistry-target coating. PWV1 will exceed PWV2. A reader simultaneously sampling both regions 20 and 16 will resolve two spectral resonance features if PWV1−PWV2 exceeds the resonance width (full width at half maximum, FWHM). However, if only a small PWV difference exists between two regions (small amount of target), then the two overlapping resonance's will appear as one broad resonance.

The design of FIG. 3 provides spectral clarity between the two regions, thus facilitating use of PWV2 (measurements from region 16) as a simultaneous reference point. This disclosure provides for separation of PWV1 and PWV2 by design rather than only by surface coating effect. In particular, the grating structure for the area of the biosensor which generates signal of value PWV2 (region 16) is designed such that PWV2 is sufficiently separated from the signal PWV1 (produced from region 20) such that the two spectral resonance features a PWV2 and PWV1 can be resolved by the detection instrument. In a typical embodiment, PWV2 and PWV1 are separated by at least 5 nm, and typically this difference will be between 5 and 15 nm, possibly more, depending on how many distinct regions with different PWVs are present on the biosensor within a given read area 30.

The combination of two features, namely 1) confinement of the deposition of surface chemistry deposit 22 to stay within a specified predetermined area (20, plus part or all of the buffer zone 18) and 2) providing the biosensor grating structure with distinct spatial regions (20 and 16) exhibiting two different resonance values (PWV1 and PWV2) of sufficient spectral separation, serve to decrease the analyte lower detection limit, and increase the signal to noise ratio at a given analyte concentration. Small target spots reduce the absolute quantity of bound analyte required to achieve a certain signal level. Introduction of intra-well referencing capability decreases biosensor noise.

In another aspect, this invention describes an approach to patterning the surface area occupied by the biosensor that facilitates creation and measurement of small target areas by low resolution, high throughput reader instruments that sample an entire well at a time. In one possible embodiment, the region 30 sampled by the reading instrument in a single read is coextensive with the entire spatial extent of the well 12.

For example, again referring to FIG. 3, in this embodiment the well area 12 is patterned with distinct functional biosensor zones producing intentionally different resonance wavelengths and having grating features that are oriented in a manner that help to contain functional compounds deposited on the biosensor surface. In one example, a biosensor 14 is placed at the bottom of a micro-plate well 12. The biosensor has three zones arranged as concentric regions. The innermost zone 20 is shaped approximately as a circle is referred to as Zone 1 produces a signal of wavelength PWV 1. A surface chemistry and target material (collectively shown a 22 in FIG. 3) are deposited in Zone 1 during use of the biosensor. A middle annular shaped buffer zone 18 circumscribes Zone 1 (22). An outer zone 16 (Zone 2) surrounds the middle buffer zone 18 and will have an annular shape for a circular well. Zone 2 (16) produces a signal of wavelength PWV2. In one example, the Zone 2 (16) covers the balance of the well. The periodicity of the subwavelength grating structures formed in the surface of the biosensor in Zones 1 (20) and 2 (16) differ sufficiently so as to separate PWV1 and PWV2 by more than the FWHM of each distinct resonance, thus ensuring that the spectrum measured over the entire well will always yield two resolvable PWVs.

The Buffer Zone 18 serves two practical purposes. First, it allows for variation in placement and spread of surface chemistry-target material 22 without compromising the reference function of Zone 2 (16). Secondly, the Buffer Zone 18 also serves to physically confine the spread of surface chemistry-target material 22. This is achieved by orienting and/or constructing the grating structures formed in the biosensor surface in the Buffer Zone 18 in a direction and orientation that discourage or inhibit outward flow of the material 22 deposited in the Zone 1, e.g., by capillary action. For example, in the embodiment of FIG. 3 the Buffer Zone 18 may consist of concentric ring grating structures. It is also possible to form the grating structures in the Buffer Zone to have a greater height than adjacent grating structures in Zone 1 to further confine the surface chemistry-target material. Manufacturing considerations, such as issues related to the pattern master fabrication, may indicate that the grating structures in the Buffer Zone have a similar height to the active subwavelength gratings of the biosensor regions in Zone 1 to allow for production of the master in one etch step. To achieve material retention features with, for example, greater height, would require a second etch process.

In another embodiment, the Buffer Zone 18 could, for example, consist of subwavelength grating structure features that produce a PWV^{buffer} which is distinct from either PWV1 (for Zone 1) or PWV2 (for Zone 2).

Continuing to refer to FIG. 3, the reader measurement area 30 will cover the majority of the well 12. Thus the spectrum produced by one well will include two or three resonance's corresponding to PWV1, PWV2, and possibly PWV^{buffer}.

The subwavelength grating structures in Zones 1 and 2 may be linear with the same orientation, or with a different orientation. They may be two dimensional structures such as arrays of holes or posts. They may also be composed of concentric rings.

The existence of Zone 2 (16) with PWV2 offers two advantages. First, as described, it allows the resonance (PWV1) from Zone 1 (20) to cleanly respond to binding on the target area (22) without influence from light interacting away from sensor areas not covered by the target. Secondly, the resonance from Zone 2 will respond to so called “bulk” effects and or “non-specific” binding and provide a reference measurement or correction factor for observed PWV1 shifts. Bulk shift occurs when the refractive index of the liquid above the biosensor 14 changes and produces a biosensor signal that does not relate to the desired detection of analyte-target binding. This occurs, for example, in response to temperature or buffer changes. Non specific binding refers to detection of analyte binding to species other than the target. Both phenomena add error to the measurement of specific analyte-target binding.

Optimization of the reader instrument for the biosensor arrangement of FIG. 3 involves designing the instrument illumination and detection optics such that it collects as much light as possible from the entire well area, i.e. from all zones. Exceeding the well boundaries does not generally cause a problem because the resonance of the biosensor covered with adhesive (used to bond the sensor 14 to the microwell plate 10 frame) occurs on the long wavelength side of the sensor's useful range. The required integration time (signal collection time) will increase in order to maintain similar peak intensity, because the area producing each resonance has decreased.

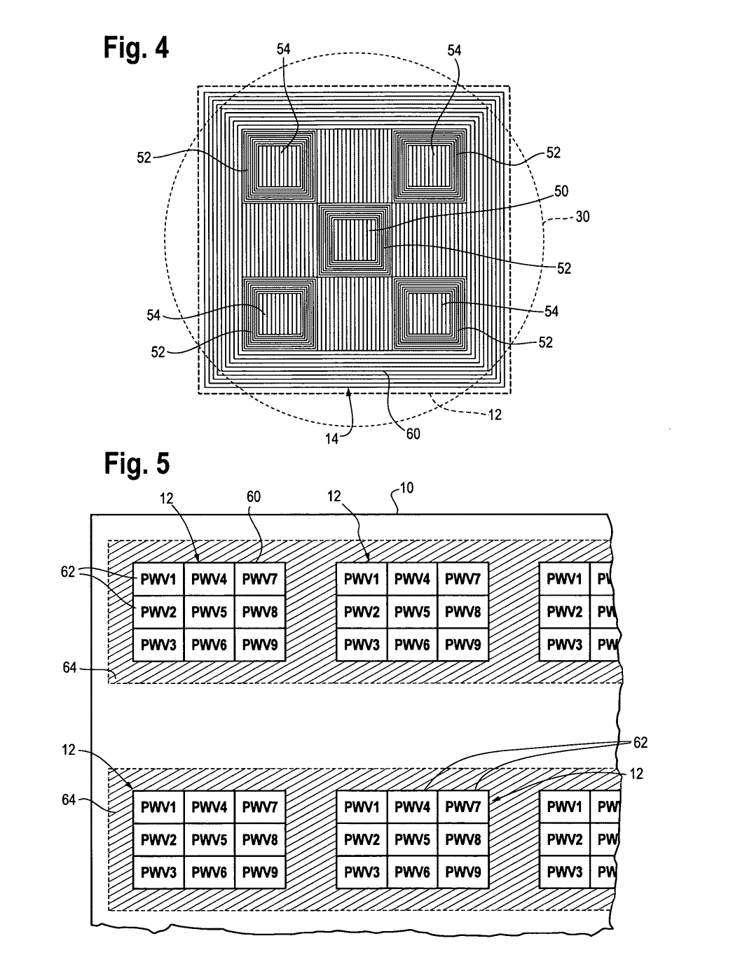

FIG. 4 illustrates a zoned biosensor 14 pattern with three different grating pitches that produces three different resonance wavelengths. The area bounded by dashed line 12 indicates the area of a square well in a 384 well micro-well plate, but the outline of the well is not important and could be circular. The area 30 indicates the region sampled by the detection instrument. The periodic surface grating at area 50 in the center of the well produces a resonance at a first wavelength. The area 50 is surrounded by a buffer area 52 comprising gratings which are oriented in alignment with the outline form of the rectangular boundary of the area 50 as shown. The buffer area 52 produces resonance at a second wavelength. The grating shown at 50 is used for primary detection in 384 well assays. The biosensor also includes four surrounding squares 54 per well, each square 54 is surrounded by an adjacent buffer area 52. There are four squares 54 per well, and 1536 of such squares per 384-well plate. The squares 54 are spaced in a manner to facilitate dual use of this pattern shown in FIG. 4 in both standard 384 and 1536 well microplate formats. The squares 54 produce resonance at a third wavelength. The target material is placed in the center of the squares 50 and/or 54 and the buffer zones 52 inhibits flow onto the external reference area, area 60. The resonance signal obtained by the external region 60 peripheral to all of the buffer zones provides a reference signal for the primary resonance signal obtained from square 50 in the center of the well.

One can extend the concept of multiple zones with distinct PWVs to yield other benefits. For example, a biosensor can be designed with a checkerboard pattern with different subwavelength grating structure period (and hence different resonance wavelengths) in each square with sufficient spectral separation between each of the squares. As the detection instrument scans over the checkerboard sensor pattern, multiple squares are imaged at each position of the reading instrument. Such a sensor can produce a low resolution spatial imaging effect while still using the large sampling area of a reader. Each resonance peak in the spectrum corresponds to a known area on the well map. Thus, one could monitor the motility of cells as they traverse a well with different PWVs.

Another much finer checkerboard pattern with the “black” squares resonating at PWV1 and the “red” squares resonating at PWV2 can effectively double the resolution of an imaging instrument because both wavelengths can be resolved simultaneously. Four resonance areas per imaged pixel would increase resolution by four. The spectral width of the light source and spectrometer limit the number of distinct PWVs that the system can resolve.

Correlating spatial location with PWV also facilitates scanning reader approaches where the reader does not need to monitor read head position precisely to achieve a given spatial resolution. For example, with a zoned sensor such as shown in FIG. 3 with Zone 1 exhibiting resonance at PWV1 and Zone 2 exhibiting resonance at PWV2, the reader “knows” that PWV1 corresponds to the center of the well. The read head can scan by the well and record the PWV1 value without stopping in a precise location.

Elaborating on the embodiment of multiple zones of PWVn forming, for example, a checkerboard like pattern with squares of multiple PWV colors, a non-pixilated, reader type instrument becomes a low resolution scanner. The reader aperture illuminates a region with n squares, each square exhibiting a unique PWV and having sufficient spectral separation between the squares such that the signals can be resolved in the instrument. In effect, the checkerboard pattern of the sensor provides the pixilation. As the reader scans it's aperture over the sensor area, the square patterns repeat with a spatial frequency that ensures the aperture only illuminates one square with PWVn at a time. The reader software can then map shifts in PWVn according to the known location of the aperture and thus generate a label free shift image with resolution=aperture size/n.

Again, the usable spectral width of the reader (light source and spectrometer) determine how many (n) zones may exist within the aperture area. Current sensor and assay practice indicates PWVn and PWVn+1 should have ˜10 nm separation. Thus, a reader with a 100 nm usable spectral width could multiplex ˜10 distinct PWV zones. Sensor manufacturing tolerances may limit this scenario to 9 zones.

Another embodiment to this invention involves patterning a well bottom with PWV zones that serve the needs of cell motility assays. As a simple example, cells can be placed in a well on a sensor zone with PWV1. The shift in PWV1 will register the attachment of these cells to the sensor surface. The cells may then be exposed to a test compound that engenders significant motion of the cells. The adjacent zone with PWV2 will register a positive shift in peak wavelength value as the cells cross the spatial division between PWV1 and PWV2 while PWV1 will shift down as cells leave this zone. Extending this concept further, the well bottom may have n striped or annular zones that monitor the progress of cells across the well. Zones distant from the initial cell seeding zone may have test compound coatings attractive to the cells. The shifts in the PWVn zones will register cell motion, as the cells migrate towards (or away) from these test coatings. An example embodiment will be described subsequently in conjunction with FIG. 10.

FIG. 5 is a plan view of a microwell test device 10 having a plurality of wells indicated at 12, with the test device structure not shown in FIG. 5 removed for sake of illustration. The biosensors for each well are constructed as a cluster of nine regions 62 arranged in rows and columns, each region constructed with a different periodic surface grating structure such that the cluster exhibits nine different resonance wavelengths. In this example, the nine regions are not separated from each other and share at least one common border with another region. The biosensor clusters 60 are separated from each other by buffer region 64 having a different PWV from the values of the nine regions to ensure aperture sampling uniqueness and provide for a self-referencing capability as explained above.

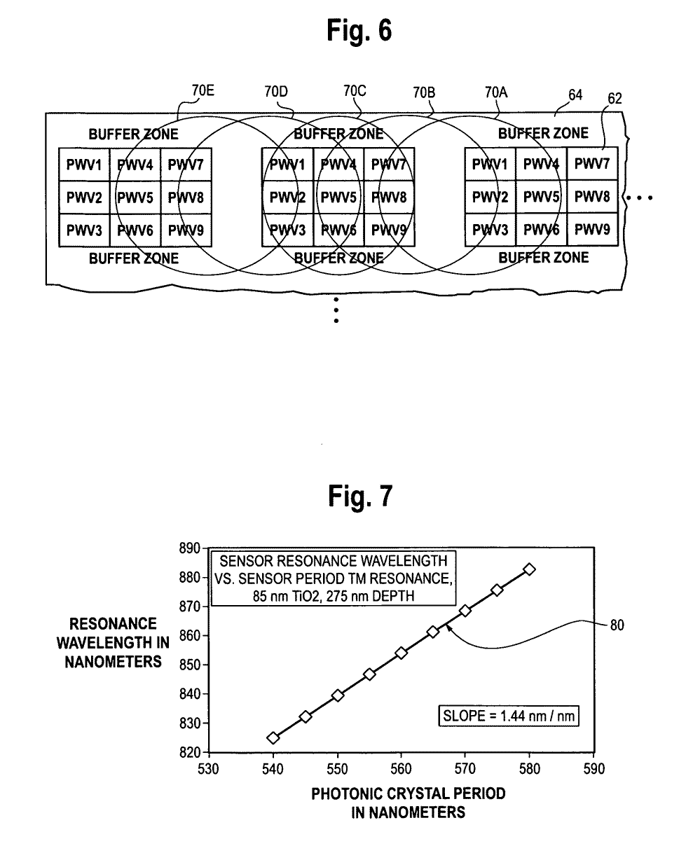

FIG. 6 is a schematic illustration of the microwell test device of FIG. 5, showing successive positions 70A, 70B, 70C, 70D, 70E in which a reader of the microwell test device obtains PWV measurements. The instrument collects peak wavelength value measurements from nine regions of the biosensor at each position 70A, 70B . . . . For example at position 70A, the instrument collects readings from PWV1 to PWV6 from the right-hand cluster and readings for PWV7, PWV8 and PWV9 from the cluster on the left. Provided sufficient spectral separation for each PWV measurements exists for each of the nine regions (preferably at least 5 nm), the instrument can obtain nine different PWV measurements at the same time. The combination of known aperture position and known PWVn zone map provides a spatially resolved PWV image such that comparing PWV values from successive scans can yield images depicting binding activity.

FIG. 7 is a plot 80 of resonance wavelength as a function of photonic crystal period for a one dimensional periodic surface grating for incident radiation in a TM mode, a grating depth of 275 nm, and an 85 nm TiO₂ high index of refraction coating on the grating. This plot shows that as the period of the grating varies from about 540 nm to 580 nm, the resonance wavelength increases at a slope of 1.44 nm per nm of increase in wavelength period. Thus, FIG. 7 shows that 9 spectrally separated resonance wavelengths with approximately 7 nm separation can be obtained by providing nine photonic crystal periods for the nine PWV regions shown in FIG. 5 and 6, with the grating periods for the nine regions being approximately 540 nm, 545 nm, 550 nm, 555 nm, 560 nm, 565 nm, 570 nm, 575 nm and 580 nm.

FIG. 8 is a detailed view of a portion of a grating-based biosensor 14 showing a portion of periodic surface grating structure and the elements of a reader for reading the biosensor. The layer 100 is the substrate material and may be glass, clear plastic, or other material. The grating structure is layer 102 and may take the form of a UV curable material. The high index of refraction material layer 104 (e.g, TiO2) is deposited on the grating layer. The circles 200 represent a target species and/or surface chemistry material which are deposited or applied to the surface of the biosensor and the “+” symbols 202 represent an analyte which binds to the target species. In some embodiments, the target species 200 is bound to the surface of the grating structure. In one possible embodiment, the target species 200 are unbound cells and the analyte 202 is a test compound which engenders significant motion in the cells. Target and/or analyte may be spatially patterned on the biosensor surface. FIG. 8 also shows the main elements of the detection instrument—a light source 110, a fiber optic bundle 112 coupled to the light source and directing light onto the surface of the biosensor as indicated at 114 and capturing reflected light at 116. The captured light is directed to a spectrometer 118. The detection instrument also includes an XY stage (not shown) to provide for relative movement of the test device relative to the optics of the detection instrument, such relative motion indicated by the arrow 150.

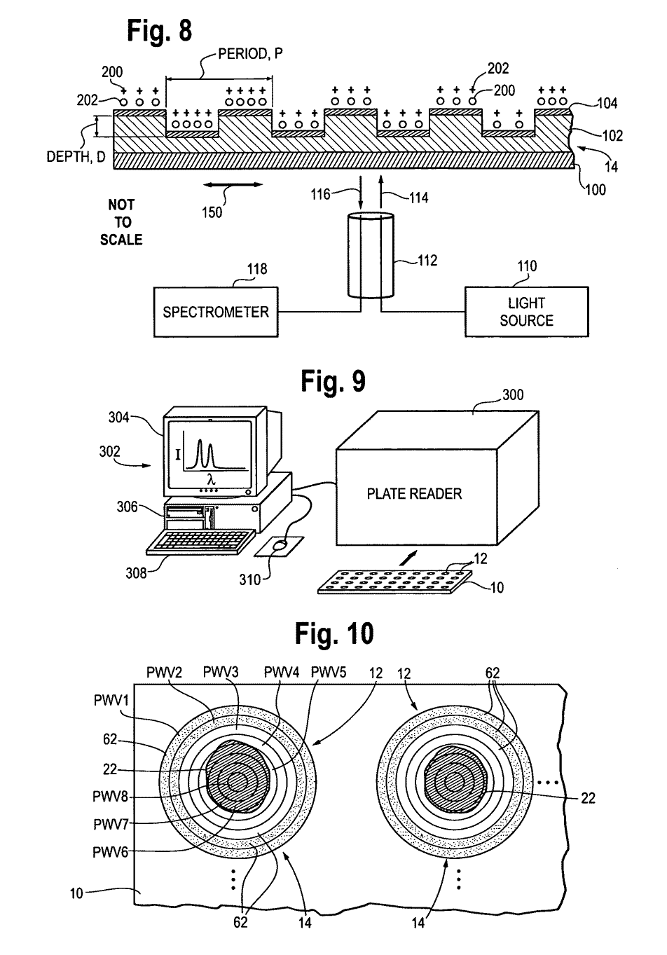

FIG. 9 is an illustration of a plate reader 300 incorporating the optical light source 110, fiber optic bundle 112 and spectrometer 118 of FIG. 8 and an associated computer workstation 302 which obtains readings from the spectrometer 118 in the plate reader. The plate reader 300 is designed to read microwell test devices 10 and obtain PWV measurements from the biosensors in the test devices 10. The workstation includes a display, central processing unit 306, keyboard 308 and mouse 310. The workstation allows the operator to view the data collected from the spectrometer on the display 304, such as plots of PWV signals as shown in FIG. 9. The plate reader may take the form of the BIND plate reader, commercially available from the applicant's assignee and described in previously referenced patent documents.

FIG. 10 is an illustration of another alternative configuration of a biosensor for a multi-well test device. The biosensor 14 is constructed as clusters or units of concentric circular regions 62 and a central region PWV8. Each region has a different grating structure such that each region exhibits a different PWV resonance wavelength, indicated by PVW1, PWV2, . . . PWV8. Each cluster is essentially coextensive with the well in the multi-well test device 10. A deposited material in the form of cells 22 are seeded onto the biosensor in approximately the middle of the cluster. The regions at the periphery of the cluster are coated with test compounds (shaded area in regions PWV1 and PWV2) which are attractive (or repulsive) to the cells. The optics of the detection instrument are designed such that data is obtained from the entire well 12 at one time. By measuring the shifts in PWV measurements in each of the regions over time, the device can be used to measure cell migration towards or away from the test coatings.

The reading instrument design limits the number n of PWV readings which can be obtained simultaneously in a device such as shown in FIGS. 4, 5, 6 or 10 or modification thereof. Conceivably, one could have significantly more than 10 zones simultaneously read. Depending on application, one might reduce the separation between zones or the size of the zones to accommodate more zones per read region. A value of n=100 is believed to be feasible.

While a number of exemplary aspects and embodiments have been discussed above, those of skill in the art will recognize certain modifications, permutations, additions and sub-combinations thereof as being present in this disclosure. It is therefore intended that the following appended claims and claims hereafter introduced are interpreted to include all such modifications, permutations, additions and sub-combinations as are within their true spirit and scope.

I claim:

1. A testing device comprising:
a multi-well test device having a multitude of sample wells, each of the wells having a bottom; and
a photonic crystal biosensor placed at the bottom of each of wells;
wherein, for each well, the photonic crystal biosensor is constructed with a first periodic grating structure designed to exhibit a first peak wavelength value in a resonance condition, the first periodic grating structure located in a first spatial region of the well, and a second periodic grating structure designed to exhibit a second peak wavelength value in a resonance condition, the second periodic grating structure located in a second spatial region of the well, wherein the first and second spatial regions comprise distinct spatial regions of the well.

2. The device of claim 1, wherein the first and second spatial regions are separated from each other by a buffer region.

3. The device of claim 2, wherein the buffer region is constructed with a periodic surface grating in a manner designed to inhibit a liquid phase material deposited in the first region to migrate into the second spatial region.

4. The device of claim 2, wherein the first spatial region has an outline form, and wherein the periodic surface grating of the buffer region is constructed with gratings which are in alignment with the outline form of the first spatial region.

5. The device of claim 4, wherein the first spatial region comprises a round outline form and wherein the buffer region comprises an annular region surrounding the round outline form and wherein the gratings of the buffer region are arranged as concentric circles.

6. The device of claim 4, wherein the first spatial region comprises a rectangular outline form having four sides, and wherein the gratings of the buffer region are oriented in alignment with the four sides of the rectangular outline form.

7. The device of claim 1, wherein the photonic crystal biosensor is constructed with at least three spatially separated regions each constructed so as to exhibit a different peak wavelength value.

8. The device of claim 7, wherein each of the peak wavelength values are spectrally separated such that each peak wavelength value can be detected by a reading instrument associated with the device reading all of the at least three spatially separated regions simultaneously.

9. The device of claim 8, wherein the spectral separation is between 5 and 15 nm.

10. The device of claim 1, wherein the first and second spatial regions are arranged in a checkerboard configuration.

11. The device of claim 7, wherein each of the spatially separated regions are arranged in rows and columns and wherein each of the spatial separated regions share a border with another of the spatially separated regions.

12. The device of claim 11, wherein the spatially separated regions are grouped into clusters, and wherein the clusters are separated from each other by buffer zones.

13. The device of claim 11, and wherein there are two or more clusters per well.

14. The device of claim 2, wherein the buffer region comprises a region exhibiting a third peak wavelength value different from the first and second peak wavelength values.

15. A test device, comprising:
structure forming a sample well, and
a biosensor placed in the sample well, wherein
the biosensor incorporates two features, namely 1) a structural feature promoting confinement of the deposited material in the well to stay within a specified predetermined area and 2) the biosensor constructed with two or more distinct spatial regions exhibiting different resonance values of sufficient spectral separation in response to illumination of the biosensor with light whereby the spectral separation can be resolved by a detection instrument reading the test device,
one of said distinct spatial regions comprising the specified predetermined area and another of said distinct spatial regions comprising a region surrounding the specified predetermined area.

16. The device of claim 15, wherein the biosensor comprises a photonic crystal biosensor and wherein the first spatial region comprises a region occupying the center of the well and wherein the second spatial region comprises a region occupying a region peripheral to the first spatial region.

17. The device of claim 15, wherein the structural feature promoting confinement of the deposited material in the well to stay within a specified predetermined area comprises periodic gratings which are oriented in alignment with a boundary of the predetermined area.

18. The device of claim 15, wherein the structural feature promoting confinement of the deposited material in the well to stay within a specified predetermined area comprises raised areas on the surface of the biosensor.

19. The device of claim 15, wherein the two or more distinct spatial regions exhibiting different resonance values comprise two spatial regions arranged in a checkerboard fashion.

20. The device of claim 15, wherein the two or more distinct spatial regions exhibiting different resonance values comprise one or more clusters of distinct spatial regions surrounded by a buffer zone.

21. The device of claim 20, wherein each of the clusters comprise at least 3 distinct spatial regions each exhibiting different resonance values.

22. The device of claim 21, wherein each of the clusters comprise between 3 and 9 spatial regions, inclusive.
